(19) United States
(12) Patent Application Publication
(10) Pub. No.: US 2013/0200656 A1
(43) Pub. Date: Aug. 8, 2013

(54) UNDERBODY PANEL ASSEMBLY AND METHOD OF MANUFACTURE

(71) Applicants: Dennis Shimmell, Montague, MI (US); James M. Palmer, Hudsonville, MI (US)

(72) Inventors: Dennis Shimmell, Montague, MI (US); James M. Palmer, Hudsonville, MI (US)

(73) Assignee: CORVAC COMPOSITES, LLC, Byron Center, MI (US)

(21) Appl. No.: 13/368,394

(22) Filed: Feb. 8, 2012

(51) Int. Cl. B62D 25/20; B23P 11/00

(52) U.S. Cl. 296/204; 29/428

(57) ABSTRACT

An underbody panel assembly and related method of manufacture is provided. The underbody panel assembly includes an underbody panel coupled to a thermal shield including a plurality of expansion joints. The expansion joints are adapted to accommodate a lengthening or shortening of the thermal shield in response to a corresponding lengthening or shortening of the underbody panel. The related method includes providing an underbody panel, providing a thermal shield including a plurality of expansion joints, and joining the thermal shield to the underbody panel at intervals. The thermal shield can be joined to the underbody panel using a plurality of welds, with each weld being proximate a separate expansion joint. The resulting underbody panel assembly can withstand repeated heating and cooling cycles along a vehicle exhaust, muffler or catalytic converter, while also reducing aerodynamic drag at high vehicle speeds, contributing to an overall increase in vehicle fuel efficiency.

### BACKGROUND OF THE INVENTION

The present invention relates to a vehicle underbody panel assembly and a related method of manufacture.

Underbody panels have traditionally been utilized to protect a vehicle undercarriage from debris and moisture. In many such instances, underbody panels also attenuate vibration and noise, potentially providing a quieter ride in the car interior.

More recently, underbody panels have been shown to provide an appreciable decrease in vehicle drag. That is, underbody panels can reduce aerodynamic drag along the undercarriage, potentially increasing fuel efficiency over certain driving speeds. However, existing metal underbody panels can add undesired weight to a vehicle, offsetting any gains achieved by a reduction in drag, particularly at slow speeds.

Molded underbody panels have been offered as an alternative to metal underbody panels. For example, thermoplastic underbody panels are lightweight and generally inexpensive to manufacture and install. However, heat from an exhaust line or other underbody components can in some instances weaken, deform or even melt thermoplastic underbody panels, rendering such panels unsuitable for use in certain regions of a vehicle undercarriage.

### SUMMARY OF THE INVENTION

The present invention provides an improved underbody panel assembly and a related method of manufacture. The underbody panel assembly includes an underbody panel coupled to a thermal shield having a plurality of expansion joints. The expansion joints are adapted to accommodate a lengthening or shortening of the thermal shield in response to a corresponding lengthening or shortening of the underbody panel. The related method includes the steps of providing an underbody panel, providing a thermal shield including a plurality of expansion joints, and joining the thermal shield to the underbody panel. The thermal shield can be joined to the underbody panel using a plurality of welds, with each weld being proximate an expansion joint.

According to one embodiment, the underbody panel assembly includes an underbody panel formed of a substantially rigid thermoplastic material. The underbody body panel may be generally shaped to reduce aerodynamic drag along the vehicle undercarriage, while also reducing vehicle noise. The thermal shield is supported along the underbody panel in regions proximate an exhaust, a muffler, a catalytic converter, or other heat source. The thermal shield is generally positioned to impede the flow of heat to the underbody panel. The thermal shield is optionally formed of strips of an insulating material, including for example compression molded polyethylene terephthalate (PET).

The underbody panel assembly optionally includes a plurality of preformed expansion joints in the thermal shield. The expansion joints can include one or more folds, pleats or gussets adapted to expand under tension with sufficient shape memory to contract when unloaded. Further optionally, the expansion joints can include V-shaped accordion folds or U-shaped corrugated folds in spaced apart intervals along the thermal shield. In these and other configurations, the expansion joints include fold lines running generally perpendicular to the thermal shield longitudinal axis. In addition, the sonic welds are generally offset, or closer to one adjacent expansion joint than to another adjacent expansion joint. The underbody panel assembly optionally includes only a single spot weld in the region between expansion joints. During heating and cooling cycles, the thermal shield remains generally flush against the underbody panel, while the expansion joints expand and contract in response to a thermal expansion and contraction of the underbody panel.

According to another embodiment, a method for manufacturing an underbody panel assembly includes vacuum molding a thermoplastic preform into an underbody panel, compression molding a PET preform into a thermal shield having a plurality of resilient expansion joints, and sonic welding the thermal shield to the underbody panel at regular or irregular intervals. The sonic welds are generally offset, being closer to one adjacent expansion joint than to another adjacent expansion joint. Optionally, each sonic weld is spaced apart from an expansion joint by less than one fourth of the distance separating successive expansion joints. Intermediate segments of the thermal shield generally rest flat against the underbody panel, and can extend around contoured or angled portions of the underbody panel.

The embodiments herein can provide an underbody panel assembly positionable along a vehicle undercarriage to improve fuel efficiency. Because the underbody panel assembly is adapted to withstand elevated temperatures from an exhaust line, for example, the underbody panel assembly can extend nearer to the exhaust line, thereby encompassing more of the vehicle undercarriage. The expansion joints can accommodate repeated lengthening and shortening of the thermal shield, which might otherwise irreversibly buckle or bow under the strain of an enlarged underbody panel.

These and other advantages and features of the present invention will be more fully understood and appreciated in view of the description of the current embodiments and the drawings.

### BRIEF DESCRIPTION OF THE DRAWINGS

FIG. 1 is perspective view of an underbody panel assembly in accordance with a first embodiment of the invention.

FIG. 2 is perspective view of an underbody panel assembly in accordance with a second embodiment of the invention.

FIG. 3 is a cross-sectional view of the underbody panel assembly of FIG. 2 taken along line 2-2.

FIG. 4 is a first flow chart for a method of manufacturing the underbody panel assemblies of FIGS. 1-3.

FIG. 5 is a second flow chart for a method of manufacturing the underbody panel assemblies of FIGS. 1-3.

### DESCRIPTION OF THE CURRENT EMBODIMENTS

The current embodiments relate to an underbody panel assembly including an underbody panel and a thermal shield, as well as methods for manufacturing the same.

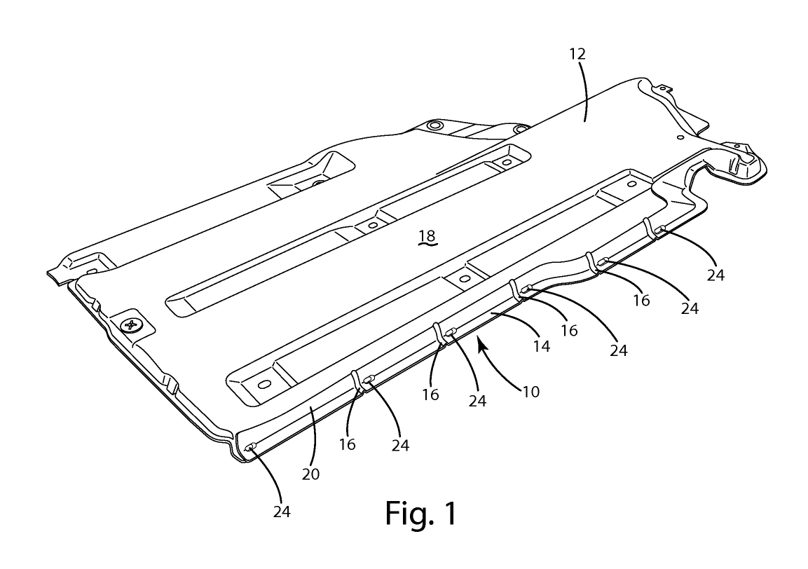

Referring now to FIG. 1, an underbody panel assembly is shown and generally designated 10. The underbody panel assembly 10 includes an underbody panel 12 positionable along a vehicle portion and a thermal shield 14 joined to the underbody panel 12. The underbody panel 12 is generally adapted to reduce drag and/or vehicle noise, and the thermal shield 14 is generally adapted to reduce the transfer of heat to or from the underbody panel 12. As explained in greater detail below, the thermal shield includes one or more expansion joints 16 to minimize irreversible deformation of the thermal shield 14 over repeated heating and cooling cycles. In addition, the thermal shield 14 extends along sub-portions of the underbody panel 12, while in other embodiments the thermal shield is coextensive with the underbody panel 12.

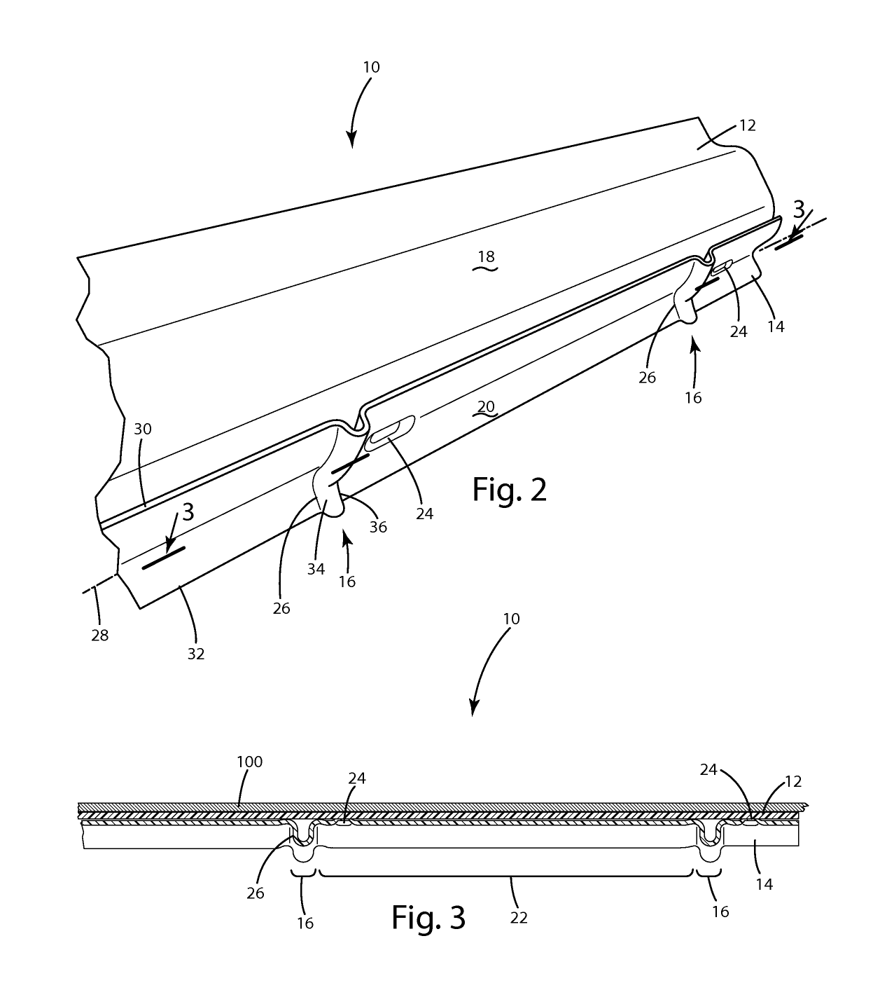

As noted above, the underbody panel 12 is generally shaped to reduce drag and/or vehicle noise with minimal added weight. For example, the underbody panel 12 can be positioned immediately below a vehicle chassis while defining a major surface 18 that is substantially parallel to the road or other driving surface. The major surface 18 can terminate proximate a high temperature heat source, including for example an exhaust pipe, a catalytic converter, or a muffler. The major surface 18 is substantially planer in FIG. 1, however the major surface 18 can be contoured as generally shown in FIGS. 2-3. The underbody panel 12 optionally includes one or more reinforcement portions, including for example one or more grooves or ribs to oppose a bending load in the underbody panel 12. In addition, the underbody panel 12 is optionally formed of a rigid or semi-rigid thermoplastic material, such as high-density polyethylene (HDPE), polypropylene (PE), polybutylene (PB) or polyvinylidene fluoride (PVDF), for example.

Depending on the melting point of the selected thermoplastic material, radiant heat from an exhaust pipe (or other heat source) can thermally deform the underbody panel 12, potentially causing undesired pockets or bubbling. To maintain the structural integrity of the underbody panel 12, the thermal shield 14 is positioned to impede the flow of heat toward the underbody panel 12 and/or to reflect heat away from the underbody panel 12. As shown in FIGS. 1-3 for example, the thermal shield 14 is joined to the underbody panel 12 with a outward facing surface 20 generally opposite a nearby heat source. The thermal shield 14 can include, for example, insulating textile materials, liners, scrim, or padding made from fibers, foam or shoddy. In the present embodiment, the thermal shield 14 is formed of polyethylene terephthalate (PET), such as NP266 available from VisTech Manufacturing Solutions, LLC of Modesto, Calif.

As also shown in FIGS. 1-3, the thermal shield 14 includes a flexible strip of insulating material extending lengthwise along a periphery of the underbody panel 12. The thermal shield 14 can be joined to the underbody panel 12 according to any suitable manner, including for example welds, rivets, adhesives, staples or clips, and at regular or irregular intervals. In the illustrated embodiment, spot welds 24 join a flexible strip of PET 14 to the underbody panel 12 at irregular intervals, with intermediate segments 22 laying flat against the underbody panel 12 in room temperature conditions. The thermal shield 14 may also extend around corners or other non-planar surfaces of the underbody panel 12, and can continue along portions of the underbody panel 12 distal from the exhaust pipe and other high temperature heat sources.

As noted above, the underbody panel assembly 10 is subject to a range of operating temperatures influenced, in part, by radiant heat from a nearby heat source and by ambient temperature variations. Under heating and cooling cycles, the underbody panel 12 and the thermal shield 14 expand and contract in proportion to their respective coefficient of thermal expansion. For example, the underbody panel 12 can expand by a greater amount or at a greater rate than the thermal shield 14 when exposed to an increasing temperature gradient. Because the underbody panel 12 and the thermal shield 14 are joined together, the thermal shield 14 can undergo tension between spot welds 24 during thermal expansion of the underbody panel 12. In order to minimize plastic deformation of the thermal shield 14 and the risk of welds failure, the expansion joints 16 absorb the expansion of the thermal shield 14 between spot welds 24. The expansion joints 16 return to their original shape during cooling cycles, caused by a shortening of the underbody panel 12 during cooling cycles. That is, the expansion 16 joints will return to their original state with sufficient shape memory for repeated expanding and contracting.

Referring again to FIGS. 1-3, the expansion joints 16 are optionally defined by inverted V-shaped or U-shaped folds having two or more fold lines 26 transverse to the thermal shield longitudinal axis 28. That is, the fold lines 26 bisect a line connecting adjacent sonic welds 24. At room temperature conditions, the V-shaped or U-shaped fold includes an inner angle of between 0 degrees and 45 degrees inclusive, optionally between 5 degrees and 25 degrees. Though only one inverted V-shaped or U-shaped fold is shown at each expansion joint 24, multiple accordion folds and/or corrugated folds can also be utilized. In these configurations, the fold lines 26 generally extend across the thermal shield 14 from a first edge portion 30 to a second edge portion 32. In addition, the spot welds 24 are shown as being offset, or closer to one adjacent expansion joint 16 than another adjacent expansion joint 16. For example, a single sonic weld 24 is placed to the right (or left) of each expansion joint 16 less than one fourth of the distance separating adjacent expansion joints 16. Optionally, a single sonic weld 24 is placed to the right (or left) of each expansion joint 16 by less than one half of the distance separating adjacent expansion joints 16. While only a single sonic weld 24 is shown between adjacent expansion joints 16, additional sonic welds may also be desirable in certain applications.

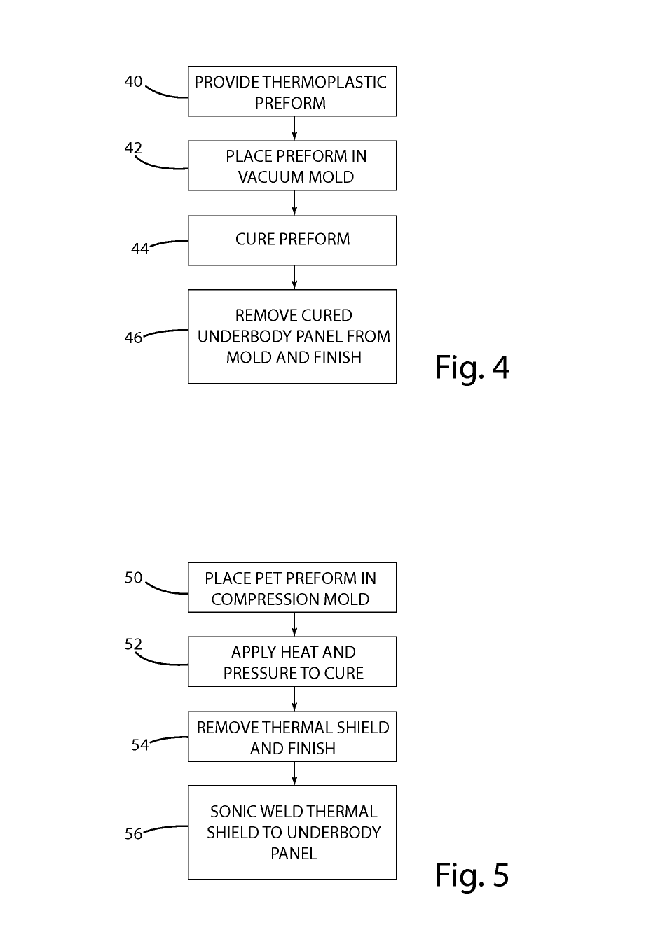

The underbody panel assembly 10 having been briefly described, a method for forming the underbody panel assembly 10 can be understood with reference to FIGS. 4-6. The method can generally including providing a thermoplastic underbody panel 12, providing a thermal shield 14 with one or more expansion joints 16, and joining the thermal shield 14 to the thermoplastic underbody panel 12 at discrete portions along the length of the thermal shield 14. The method steps can optionally be performed separately from each other. For example, the thermal shield 14 can be pre-molded and subsequently joined to the underbody panel 12 by a purchasing entity.

With reference to the flow diagram of FIG. 4, the thermoplastic underbody panel can be formed according to the following steps. At step 40, a thermoplastic preform is provided. The thermoplastic preform can include any material having desired properties, e.g. density, rigidity, melting point and cost. For example, the preform can include rigid or semi-rigid thermoplastics such as HDPE, PE, PB or PVDF as generally set forth above. The preform can be inserted into a mold at step 42, and thereafter vacuum molded into the desired shape at step 44. Alternative molding processes may also be utilized, including for example blow molding techniques and compression molding techniques. The resulting underbody panel 12 is removed from the mold and finished (e.g., deburring, cutting, stamping) at step 46 for subsequent attachment to a thermal shield 14. As noted above, the rigid or semi-rigid underbody panel 12 can optionally include one or more reinforcement portions, including for example one or more grooves or ribs to oppose a bending load in the underbody panel 12.

The method of the present embodiment further includes forming the thermal shield 14 as described below in connection with the flow diagram of FIG. 5. At step 50, the method can generally include inserting a PET preform into a compression mold. A suitable compression mold can includes upper and lower mold halves defining a mold cavity having the exterior shape of the thermal shield 14. The mold cavity includes projection-recession pairings corresponding to the expansion joints 16 in the finished thermal shield 14. To minimize the overall weight of the thermal shield 14, the preform is generally free of glass fiber additives. In the present embodiment, the PET preform includes a binder, including for example a bicomponent fiber binder. At step 52, the mold halves are driven together, and the PET preform is cured under high temperature and pressure. The cured thermal shield 14 is removed from the compression mold at step 54, and includes expansion joints at regular or irregular intervals along its length. In this initial configuration, the expansion joints 16 include an inner angle α of between 0 degrees and 45 degrees, optionally between 5 degrees and 25 degrees. In addition, the height of each expansion joint 16 can be selected such that the inner angle α does not increase beyond a predetermined angle β, optionally 30, 45 or 60 degrees. For example, the thermal shield 14 can be formed with a V-shaped expansion joint having two legs 34, 36 joined along a bend or fold line with an inner angle α. The legs 34, 36 can be formed with a height such that the expected lengthening of the thermal shield 14 during normal heating cycles will not increase beyond β. For example, the legs 34, 36 can be compression molded with a height of 8 mm and an inner angle α of 10 degrees to accommodate up to 6.6 mm of expansion while not exceeding an angle β of 60 degrees. By molding the expansion joints 16 with a sufficient height, the expansion joints 16 can therefore retain sufficient shape memory to contract to the inner angle α during cooling cycles.

Once the thermal shield 14 is removed from the compression mold, the thermal shield 14 is ready for attachment to the underbody panel 12. At step 56, the thermal shield 14 is spot welded to the underbody panel 12 at spaced apart portions of the thermal shield 14. Welding of the thermal shield 14 to the underbody panel 12 can be performed according to any suitable technique, including for example ultrasonic welding, radio frequency welding, and arc welding. The spot welds 24 are generally offset, i.e. closer to one adjacent expansion joint 16 than to another adjacent expansion joint 16. For example, a sonic weld 24 can be a distance X from a first adjacent expansion joint 16 and a distance 4X from a second adjacent expansion joint 16. Other multiples of X can also be utilized, include multiples of between 1.5 and 10, inclusive. Intermediate segments 22 generally rest flat against the underbody panel 12 in room temperature conditions. In addition, the cured thermal shield 14 can molded to conform to a specific contour of the underbody panel 12. As a result, the thermal shield 14 may also extend around corners or other non-planar surfaces of the underbody panel 12, and can continue along portions of the underbody panel 12 distal from high temperature heat sources.

To reiterate, step 56 includes introducing multiple welds 24 between the underbody panel 12 and the overlying thermal shield 14. Alternative attachment techniques can also be utilized, including rivets, pins, clips or screws, for example. In addition, the thermal shield 14 can include expansion joints 24 in some regions but not other regions. For example, the thermal shield 14 can include expansion joints 24 in regular intervals along predominantly straight sections, with minimal or perhaps no expansion joints 24 near curved or angled portions of the underbody panel 12. In addition, the expansion joints 24 can alternatively be formed in the thermal shield 14 after the curing process of step 52, including for example the manual introduction of a folds or gussets at regular or irregular intervals.

The completed underbody panel assembly 10 is positionable along a vehicle undercarriage 100 to improve fuel efficiency and noise reduction. For example, left and right side underbody panel assemblies 10 are positionable on either side of an exhaust line on a vehicle undercarriage. Because the thermal shield or liner 14 is adapted to withstand elevated temperatures from the exhaust line, the left and right side underbody panel assemblies 10 extend nearer to the exhaust line, thereby encompassing more of the vehicle underbody. As a result, underbody drag is reduced at high vehicle speeds, contributing to an overall increase in fuel efficiency. In addition, the expansion joints 16 accommodate repeated heating and cooling cycles, which might otherwise compromise the spot welds 24 and/or form gaps in the region between the underbody panel 12 and the thermal shield 14. The present invention can additionally utilize a minimal number of spot welds, while also saving material and manpower costs in the assembly of underbody panel assemblies 10. For illustrative purposes, the current embodiments are described in connection with an underbody panel, however, the present invention can be utilized in connection other protective panels, including for example the vehicle underhood. In these or other embodiments, the underbody panel 12 can additionally be formed of non-polymeric materials, including for example fiberglass or metals such as aluminum and aluminum alloy.

The above descriptions are those of the current embodiments of the invention. Various alterations and changes can be made without departing from the spirit and broader aspects of the invention as defined in the appended claims, which are to be interpreted in accordance with the principles of patent law including the doctrine of equivalents. Any reference to elements in the singular, for example, using the articles “a,” “an,” “the,” or “said,” is not to be construed as limiting the element to the singular.

1. An underbody panel assembly comprising:
an underbody panel positionable along a vehicle portion; and
a thermal shield joined to the underbody panel at intervals and including a plurality of expansion joints, wherein the plurality of expansion joints are adapted to accommodate a lengthening and shortening of the thermal shield in response to a corresponding lengthening and shortening of the underbody panel.

2. The underbody panel assembly of claim 1 wherein the intervals are one of regular intervals and irregular intervals.

3. The underbody panel assembly of claim 1 further including a plurality of welds to join the thermal shield to the underbody panel.

4. The underbody panel assembly of claim 3 wherein each of the plurality of welds are proximate a separate one of the plurality of expansion joints.

5. The underbody panel assembly of claim 1 wherein the plurality of expansion joints include one of an accordion fold and a corrugated fold.

6. The underbody panel assembly of claim 1 wherein the underbody panel is formed of a substantially rigid thermoplastic material.

7.-13. (canceled)

14. A protective panel assembly comprising:
a thermoplastic panel defining a first coefficient of thermal expansion; and
a thermal liner supported along the thermoplastic panel and defining a second coefficient of thermal expansion less than the first coefficient of thermal expansion, the thermal liner including a plurality of expansion joints adapted to expand and contract in response to a heat-induced expansion and contraction of the thermoplastic panel.

15. The protective panel assembly of claim 14 further including a plurality of welds joining the thermal liner to the thermoplastic panel.

16. The protective panel assembly of claim 15 wherein each of the plurality of welds is proximate one of the plurality of expansion joints.

17. The protective panel assembly of claim 15 wherein each of the plurality of welds is a sonic weld.

18. The protective panel assembly of claim 14 wherein the plurality of expansion joints include at least one of a fold, a gusset and a pleat.

19. The protective panel assembly of claim 14 wherein the thermoplastic panel includes high density polyurethane.

20. The protective panel assembly of claim 14 wherein the thermal liner includes polyethylene terephalate.
